(19) United States
(12) Patent Application Publication
(10) Pub. No.: US 2003/0133504 A1
(43) Pub. Date: Jul. 17, 2003

(54) Image coding integrated circuit capable of reducing power consumption according to data to be processed

(75) Inventors: Atsuo Hanami, Hyogo (JP); Tetsuya Matsumura, Hyogo (JP); Satoshi Kumaki, Hyogo (JP)

Correspondence Address: McDERMOTT, WILL & EMERY, 600 13th Street, N.W., Washington, DC, 20005-3096, US

(73) Assignee: MITSUBISHI DENKI KABUSHIKI KAISHA

(21) Appl. No.: 10/261,495

(22) Filed: Oct. 2, 2002

(30) Foreign Application Priority Data
Jan. 11, 2002 (JP) 2002-004165(P)

(51) Int. Cl. H04N 7/12

(52) U.S. Cl. 375/240.16; 375/240.26

(57) ABSTRACT

A frequency of an operating clock signal to be supplied to a video interface section, an audio interface section, a motion predicting section for conducting motion prediction of image data, a loop processing section for predictive-coding each image data based on a plurality of image data at different points of time on a time base and the motion prediction result, a DSP (Digital Signal Processor) section for coding an audio signal, and a DRAM (Dynamic Random Access Memory) interface section is separately adjusted according to the processing load of an image coding integrated circuit.

### BACKGROUND OF THE INVENTION

1. Field of the Invention

The present invention relates to the structure of an image coding integrated circuit for compressing an image by inter-frame or intra-field image processing according to the MPEG-2 (Moving Picture Experts Group 2) standard or the like.

2. Description of the Background Art

Recently, MPEG-2 coding technology is used for high-quality image recording and high-quality image transmission such as digital broadcasting. The MPEG-2 coding technology is described in detail in, e.g., “Saishin MPEG Kyokasho (Latest MPEG Text)”, Hiroshi Fujiwara, ASCII Corporation, Aug. 1, 1994) (hereinafter, referred to as “Document 1”). As described in Document 1, MPEG-2 can be used in a very wide range of applications, and operation thereof significantly varies depending on a resolution of an image or the like.

The structure and operation of a conventional MPEG-2-based image coding integrated circuit are described in, e.g., “A Single-Chip MPEG-2 422P@ML Video, Audio, and System Encoder with a 162 MHz Media-Processor Core and Dual Motion Estimation Cores” (IEICE TRANSACTIONS on Electronics, VOL. E84-C, NO. 1, JANUARY 2001) (hereinafter, referred to as “Document 2”).

Such an MPEG-2-based image coding integrated circuit generally has a high integration level so that it can be used in a wide range of applications. The image coding integrated circuit therefore tends to incorporate functions that are not necessarily required for a specific application.

As a result, such a versatile image coding integrated circuit consumes a large amount of power.

For example, although a commonly used image coding integrated circuit has voice coding circuitry, a monitoring camera system using such an image coding integrated circuit does not require the voice coding circuitry. Even if no voice signal is applied, the voice coding circuitry is in the standby state and therefore consumes power during operation of the image coding integrated circuit.

Moreover, some applications require conversion of a resolution. When the image coding integrated circuit converts a resolution (e.g., when the image coding integrated circuits codes a signal of HDTV (High Definition Television) size into a signal of SDTV (Standard Definition Television) size, it need only exert about one-sixth of its operation capability.

Actually, however, when an HDTV video signal is applied, an image coding integrated circuit is commonly operated at an operating frequency corresponding to the HDTV video signal. Power consumption increases in proportion to an operating frequency. Therefore, power consumption of the circuit would be reduced if the operating frequency can be suppressed. However, since the image coding integrated circuit is operated at an operating frequency corresponding to the HDTV video signal, it consumes an excessive amount of power.

### SUMMARY OF THE INVENTION

It is an object of the present invention to provide an image coding integrated circuit capable of reducing power consumption by suppressing redundant capability or stopping unnecessary functions.

In summary, according to one aspect of the present invention, an image coding integrated circuit includes an image signal interface, an audio signal interface, a motion predicting section, a loop processing section, a processor section, a memory interface section, and a clock signal supply circuit.

The image signal interface receives and outputs image data from and to outside. The audio signal interface receives an audio signal from the outside. The motion predicting section conducts motion prediction of the image data. The loop processing section predictive-codes each image data based on a plurality of image data at different points of time on a time base and the motion prediction result. The processor section codes at least the audio signal. The memory interface section receives and outputs data from and to a memory device for storing the image data. The clock signal supply circuit separately adjusts a frequency of an operating clock signal to be supplied to the image signal interface, the audio signal interface, the motion predicting section, the loop processing section, the processor section and the memory interface section according to processing load of the image coding integrated circuit for the image data.

According to another aspect of the present invention, an image coding integrated circuit includes an image signal interface, an audio signal interface, a motion predicting section, a loop processing section, a processor section, a memory interface section, and a clock signal supply circuit.

The image signal interface receives and outputs image data from and to outside. The audio signal interface receives an audio signal from the outside. The motion predicting section conducts motion prediction of the image data. The loop processing section predictive-codes each image data based on a plurality of image data at different points of time on a time base and the motion prediction result. The processor section codes at least the audio signal. The memory interface section receives and outputs data from and to a memory device for storing the image data. At least one of the image signal interface, the audio signal interface, the motion predicting section, the loop processing section, the processor section and the memory interface section includes a plurality of operation units for conducting a corresponding operation in parallel. The clock signal supply circuit is capable of separately discontinuing supply of an operating clock signal to the plurality of operation units according to processing load of the image coding integrated circuit for the image data.

Preferably, the image coding integrated circuit further includes a power supply voltage reducing circuit for separately reducing a power supply potential to be supplied to the image signal interface, the audio signal interface, the motion predicting section, the loop processing section, the processor section and the memory interface section by a prescribed value when the operating clock signal having a frequency lower than that of a reference clock signal is supplied.

Accordingly, an advantage of the present invention is that the frequency of an operating clock to be supplied to each component is adjusted according to the processing load, whereby power consumption can be reduced while allowing the image coding integrated circuit to be used in a wide range of applications.

Another advantage of the present invention is that supply of an operating clock to at least one of a plurality of operation units in each component is discontinued according to the processing load, whereby power consumption can be reduced while allowing the image coding integrated circuit to be used in a wide range of applications.

A further advantage of the present invention is that a power supply potential to be supplied is reduced according to the frequency of an operating clock, whereby power consumption can further be reduced.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic block diagram showing the structure of an image coding integrated circuit 1000 according to a first embodiment of the present invention.

FIG. 2 is a conceptual diagram illustrating operation of a loop processing portion 13 in FIG. 1 by using functional blocks.

FIG. 3 is a schematic block diagram of clock distribution circuitry in image coding integrated circuit 1000 of FIG. 1.

FIG. 4 is a schematic block diagram showing the structure of a frequency divider 23.

FIG. 5 is a timing chart illustrating operation according to each image format in the first embodiment.

FIG. 6 is a schematic block diagram showing the structure of a frequency divider 23 for the loop processing section 13 in FIG. 3 according to a second embodiment of the present invention.

FIG. 7 is a schematic block diagram showing the structure of a frequency divider 24 for a motion predicting section 14.

FIG. 8 is a timing chart illustrating operation according to each image format in the second embodiment.

FIG. 9 is a timing chart in a period of processing a single picture in both normal and high-definition modes according to the second embodiment.

FIG. 10 is a schematic block diagram showing the structure of an image coding integrated circuit 1010 according to a third embodiment of the present invention.

FIG. 11 is a schematic block diagram of clock distribution circuitry in image coding integrated circuit 1010 of FIG. 10.

FIG. 12 is a schematic block diagram of the structure that implements operation of two chips (i.e., image coding integrated circuits 1010, 1020).

FIG. 13 is a schematic block diagram showing the structure of a frequency divider 23 for a loop processing section 13 in FIG. 11.

FIG. 14 is a schematic block diagram showing the structure of a frequency divider 24 for a motion predicting section 14 according to a fourth embodiment of the present invention.

FIG. 15 shows a frequency division ratio selected according to a prediction range and an image format.

FIG. 16 is a conceptual diagram showing a specific on-chip layout of image coding integrated circuit 1000 of the second embodiment.

FIG. 17 is a schematic block diagram showing the structure of a power supply voltage regulator 99.1.

FIG. 18 illustrates operation of power supply voltage regulator 99.1 in FIG. 17.

FIG. 19 is a schematic block diagram showing another structure of the clock distribution circuitry in image coding integrated circuit 1000 of FIG. 1.

FIG. 20 is a schematic block diagram showing the structure of a digital signal processor (DSP) section 10 and a clock controller 110 for DSP section 10.

FIG. 21 shows the structure of a motion predicting section 14 and a clock controller 114 for motion predicting section 14 in image coding integrated circuit 1000.

FIG. 22 shows the number of motion prediction cores selected according to a motion prediction range and an image format.

FIG. 23 is a schematic block diagram showing another structure of motion predicting section 14 and clock controller 114 for motion predicting section 14 in image coding integrated circuit 1000.

FIG. 24 is a conceptual diagram of another clock distribution circuitry in image coding integrated circuit 1010 of FIG. 10.

FIG. 25 is a schematic block diagram illustrating the structure of a loop processing section 13 and a clock controller 113 for loop processing section 13 in image coding integrated circuit 1010.

FIG. 26 is a schematic block diagram illustrating the structure of a variable-length coding section 15 and a clock controller 115 for variable-length coding section 15 in image coding integrated circuit 1010.

FIG. 27 is a schematic block diagram illustrating the structure of an audio interface (I/F) section 17 and a clock controller 117 for audio I/F section 17 in image coding integrated circuit 1010.

### DESCRIPTION OF THE PREFERRED EMBODIMENTS

Hereinafter, embodiments of the present invention will be described with reference to the accompanying drawings.

[First Embodiment]

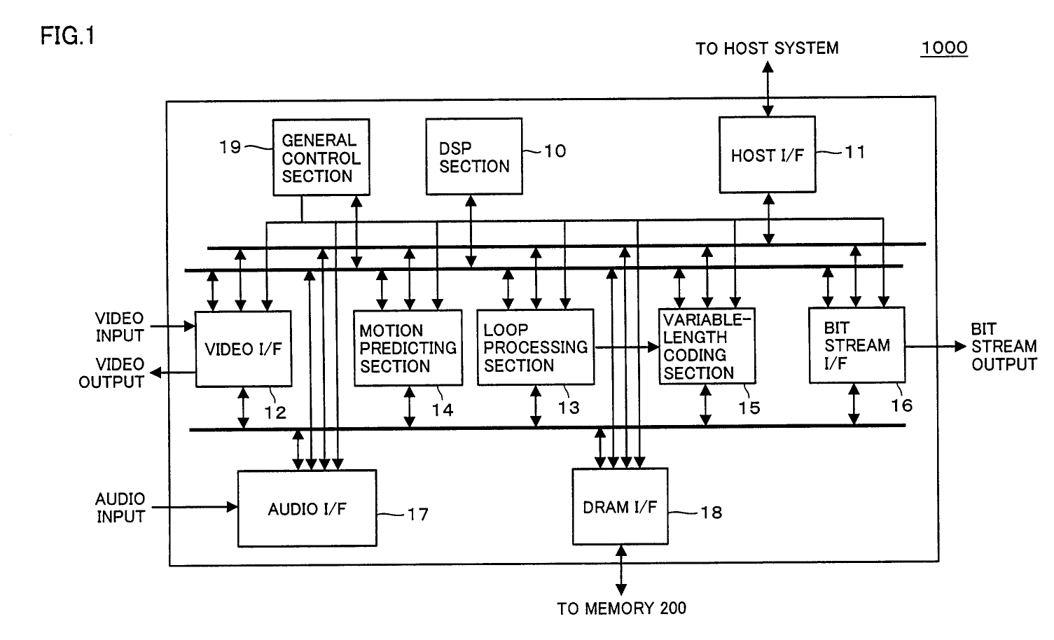

FIG. 1 is a schematic block diagram showing the structure of an image coding integrated circuit 1000 according to the first embodiment of the present invention.

Image coding integrated circuit 1000 includes the following components: a digital signal processor (DSP) section 10 for conducting audio coding operation and the like; a host interface (I/F) section 11 for receiving a control signal from a host system using image coding integrated circuit 1000; a video interface (I/F) section 12 for receiving and outputting a video signal from and to the outside of image coding integrated circuit 1000; a loop processing section 13 for conducting loop processing such as DCT (Discrete Cosine Transform) and quantization in MPEG-2-based coding operation; a motion predicting section 14 for conducting motion prediction to compensate for a video signal applied to loop processing section 13; a variable-length coding section 15 for conducting variable-length coding operation in response to an output signal of loop processing section 13; a bit stream interface (I/F) section 16 for outputting the variable-length-coded data to the outside of image coding integrated circuit 1000 as a bit stream; an audio interface (I/F) section 17 for receiving an audio input and applying it to DSP section 10; a DRAM (dynamic random access memory) interface (I/F) section 18 for interfacing with a DRAM 200 (not shown in FIG. 1) provided outside image coding integrated circuit 1000; and a general control section 19 for controlling the overall coding operation of image coding integrated circuit 1000. DRAM 200 is an image memory for temporarily storing image data in operations such as intra-frame or intra-field coding operation and inter-frame or inter-field motion prediction.

It is herein assumed that image coding integrated circuit 1000 is capable of coding an SDTV image. More specifically, provided that the video input has D 1 size, image coding integrated circuit 1000 is capable of processing 1,350 macroblocks in 1/30 second.

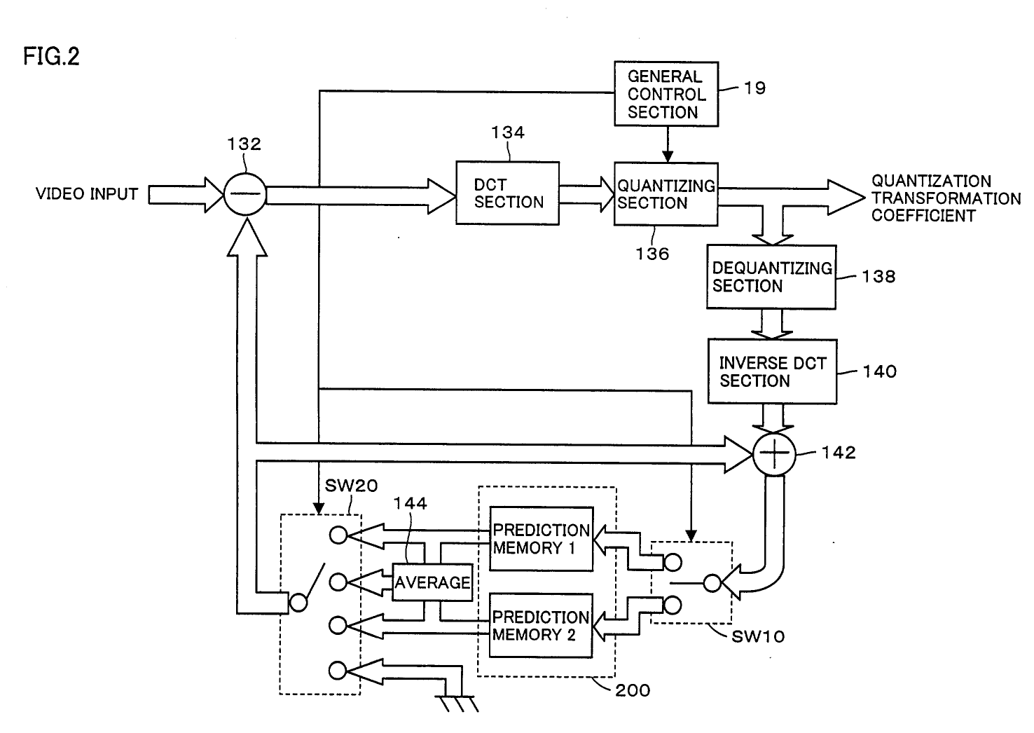

FIG. 2 is a conceptual diagram illustrating operation of loop processing section 13 in FIG. 1 by using functional blocks.

Since operation of loop processing section 13 is described in detail in Document 1 and the like, brief description thereof will be given below.

The most important point of MPEG-2 is a compression method that enables improvement in compression ratio of moving pictures and implementation of fast-forward and rewind functions.

There are three types of pictures in MPEG-2: P-picture (Predictive-coded picture) for forward prediction; B-picture (Bidirectionally predictive-coded picture) for bidirectional prediction; and I-picture (Intra-coded picture) for intra-frame coding. P-picture and B-picture are used to compress the moving pictures in the time base direction as well, and I-picture is used to implement the fast-forward and rewind functions.

In order to code these three types of pictures, an input video signal applied to video I/F section 12 in FIG. 1 is temporarily stored in image memory 200 over several frames for timing adjustment.

It is herein assumed that coded image signals corresponding to a plurality of past frames (or fields) have been stored in image memory 200 as images for prediction described later.

The video signal thus stored in image memory 200 for timing adjustment is applied to loop processing section 13 in FIG. 2. In order to code P-picture, loop processing portion 13 conducts forward prediction by using the output of image memory 200 as a prediction signal for the input image and thus obtains a prediction error.

In order to code B-picture, loop processing section 13 reads an image to be coded from those stored image memory 200 for timing adjustment, and also reads images corresponding to received images of past and future frames (or fields) from image memory 200. Loop processing section 13 then conducts bidirectional prediction by using the received images of the past and future frames (or fields) as prediction images and thus obtains a prediction error.

In order to code I-picture, loop processing section 13 directly uses the input image.

Accordingly, a switch circuit SW20 switches a signal according to the type of picture to be coded (i.e., I-picture, P-picture or B-picture) and applies the signal to one end of a difference unit 132. An input video signal is applied to the other end of difference unit 132.

A DCT (Discrete Cosine Transform) section 134 transforms an output signal of difference unit 132 into a DCT coefficient. A quantizing section 136 quantizes the DCT coefficient and applies the quantized DCT coefficient to variable-length coding section 15 together with motion position information. By entropy coding, variable-length coding section 15 assigns a shorter code to a more probable signal and a longer code to a less probable signal, and outputs the assigned codes to bit stream I/F section 16 as a coded signal.

In order to produce the same prediction signal as that produced by the decoder, the encoder also decodes the DCT coefficient by dequantizing the output of quantizing section 136 in a dequantizing section 138, as shown in FIG. 2. An inverse DCT section 140 then transforms the decoded DCT coefficient into a prediction error signal, and an adder 142 restores I-picture, P-picture and B-picture by using the prediction error and the motion position information. The I-picture, P-picture and B-picture thus restored are stored in image memory 200 through a switch circuit SW10 as a prediction signal for the subsequent input image.

Accordingly, in “prediction coding” in MPEG-2, a signal value of a certain pixel is represented by the difference from a signal value of an image at another time (past or future). Switch circuit SW20 switches operations such as intra-frame prediction coding using no data for prediction stored in image memory 200, forward inter-frame (or inter-field) prediction coding and backward inter-frame (or inter-field) prediction coding both using data for prediction, and interpolative prediction coding based on the average of the forward inter-frame (or inter-field) prediction and the backward inter-frame (or inter-field) prediction.

Accordingly, image memory 200 has at least two prediction memory regions. Image information for prediction from the future and image information for prediction from the past are stored in the two prediction memory regions. In the interpolative inter-frame prediction coding, two predictions (forward prediction and backward prediction) are averaged between corresponding pixels.

The data processing loop formed by difference unit 132, DCT section 134, quantizing section 136, dequantizing section 138, inverse DCT section 140, adder 142, switch circuit SW10, memory 200 and switch circuit SW20 as shown in FIG. 2 is herein referred to as “loop processing”.

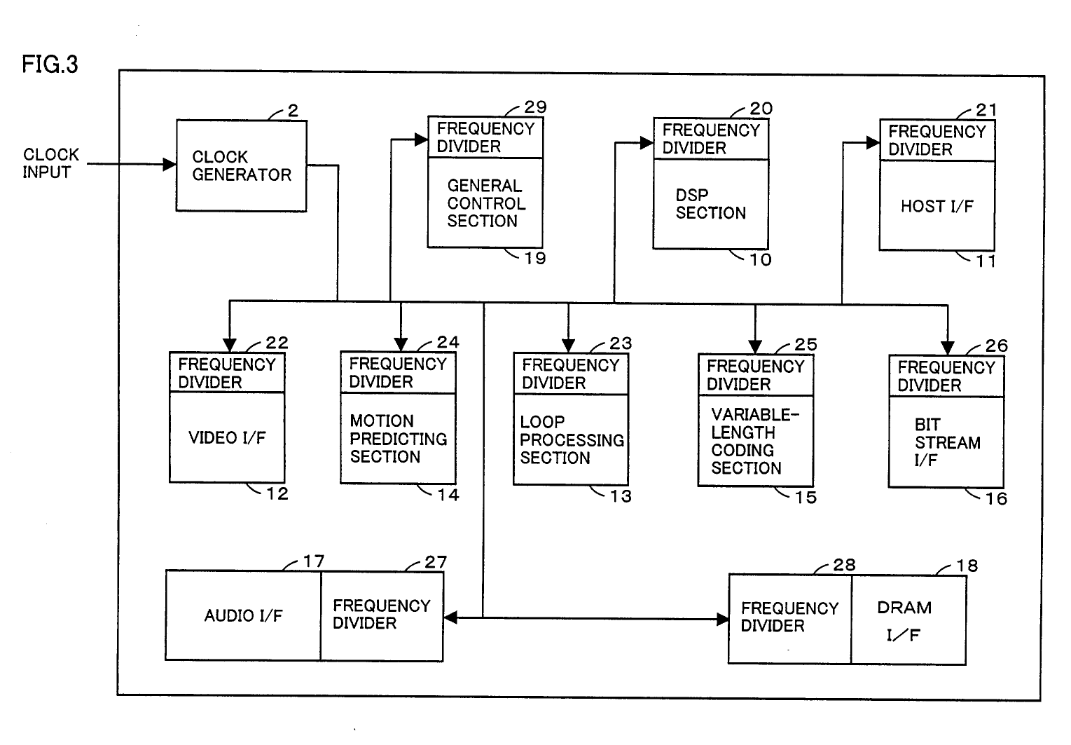

FIG. 3 is a schematic block diagram of clock distribution circuitry in image coding integrated circuit 1000 of FIG. 1.

Referring to FIG. 3, a clock generator 2 (which is not shown in FIG. 1) supplies a clock signal to the following frequency dividers through a clock supply line in response to an external clock input: a frequency divider 20 for DSP section 10; a frequency divider 21 for host I/F section 11; a frequency divider 22 for video I/F section 12; a frequency divider 23 for loop processing section 13; a frequency divider 24 for motion predicting section 14; a frequency divider 25 for variable-length coding section 15; a frequency divider 26 for bit stream I/F section 16; a frequency divider 27 for audio I/F section 17; a frequency divider 28 for DRAM I/F section 18; and a frequency divider 29 for general control section 19. Each of the sections from DSP section 10 to general control section 19 operates in response to a clock signal having a frequency divided by a corresponding frequency divider.

Clock generator 2 generates a clock having an operating frequency fO that is equal to the least common multiple of the operating frequencies of the above sections.

General control section 19 simultaneously sends a signal indicating a resolution of an image to be coded to each section so that each of the interface sections and the other sections can independently change the clock frequency.

It is herein assumed that loop processing section 13, motion predicting section 14, variable-length coding section 15 and DRAM I/F section 18 normally operate with operating frequency f0.

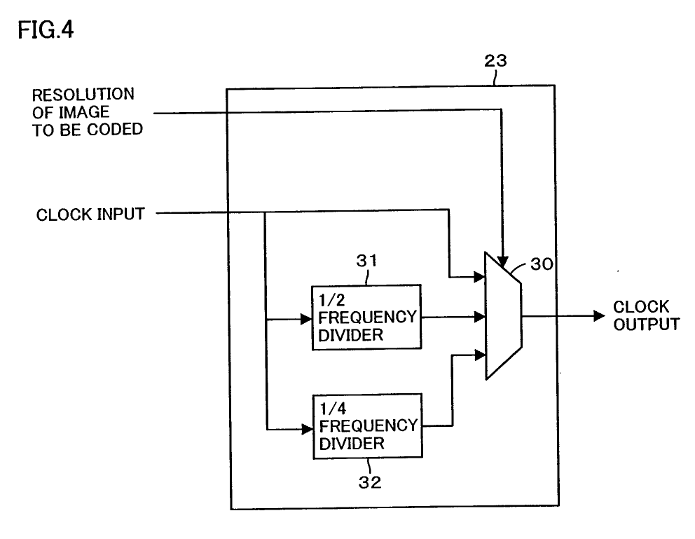

FIG. 4 is a schematic block diagram showing the structure of I frequency divider 23. The other frequency dividers 24, 25, 28 basically have the same structure as that of frequency divider 23.

Frequency divider 23 includes a ½ frequency divider 31, a ¼ frequency divider 32 and a clock selector 30.

When the resolution of an image to be coded (i.e., signal received from general control section 19) is D1 size, clock selector 30 directly outputs the input clock. When the resolution is half D1 size, clock selector 30 selects the output of frequency divider 31. When the input video signal is an SIF (Source Input Format) signal, clock selector 30 selects the output of frequency divider 32.

The other frequency dividers 20, 21, 22, 26, 27, 29 operate with a fixed frequency.

For example, 660 macroblocks are required to be coded in order to convert a D1 input image into a half-D1 image by resolution conversion. Accordingly, each of the sections involved in image coding operation (i.e., loop processing section 13, motion predicting section 14, variable-length coding section 15 and DRAM I/F section 18) need only exert half the respective processing capability.

However, video I/F section 12 receives the D1 image that has not been subjected to resolution conversion. Therefore, video I/F section 12 must exert its maximum processing capability. Since the resolution of the image has no influence on audio, audio I/F section 17 also need conduct operation corresponding to the D1 size.

By selecting half the operating frequency in frequency dividers 23, 24, 25, 28, desired resolution conversion can be conducted while reducing power consumption of the sections involved in image coding operation (loop processing section 13, motion predicting section 14, variable-length coding section 15 and DRAM I/F section 18) about by half.

Similarly, 330 macroblocks are required to be coded in order to convert a D1 input image into an SIF image by resolution conversion. Accordingly, each of the sections involved in image coding operation (loop processing section 13, motion predicting section 14, variable-length coding section 15 and DRAM I/F section 18) need only exert a quarter of the respective processing capability.

By selecting a quarter of the operating frequency in frequency dividers 23, 24, 25, 28, power consumption of the sections involved in image coding operation (loop processing section 13, motion predicting section 14, variable-length coding section 15 and DRAM I/F section 18) can be reduced to about a quarter.

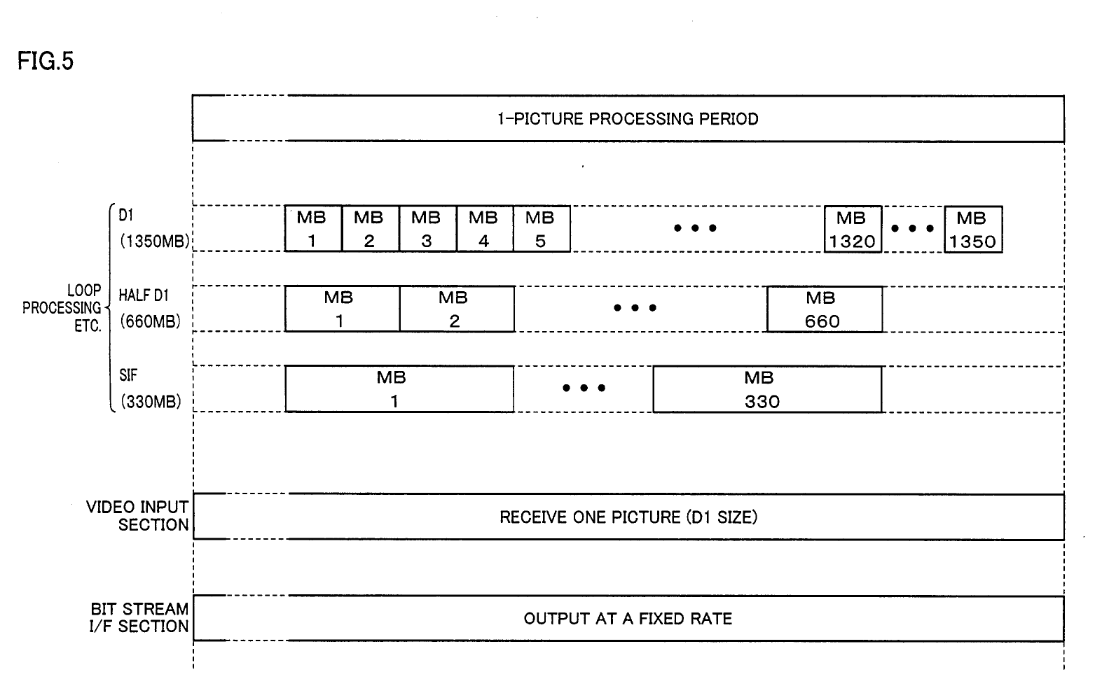

FIG. 5 is a timing chart illustrating operation according to each image format in the first embodiment.

In FIG. 5, each box represents operation in one cycle. A smaller box represents operation at a higher frequency, and a larger box represents operation at a lower frequency.

In loop processing section 13 and motion predicting section 14, the amount of operation significantly increases depending on the number of macroblocks to be coded. Therefore, as shown in FIG. 5, the operating frequency is reduced according to the total number of macroblocks corresponding to an image format, thereby enabling suppression of power consumption.

On the other hand, video I/F section 12 receives a fixed video format (in FIG. 5, D1 size) from the outside. Therefore, the operation frequency cannot be reduced.

Similarly, bit stream I/F section 16 often outputs a signal at a fixed rate in applications such as broadcasting. Therefore, the operation frequency cannot be reduced in this section.

The sections involved in image coding operation consume a large amount of power due to large circuit scale and high operating frequency. However, appropriately selecting the operating frequency in these sections according to a resolution of the image enables significant reduction in the overall power consumption of the image coding integrated circuit.

Note that frequency dividers 23, 24, 25, 28 in FIG. 3 always operate at the same frequency division ratio with respect to each other. Therefore, loop processing section 13, motion predicting section 14, variable-length coding section 15 and DRAM I/F section 18 may share a common frequency divider in order to reduce the chip area of image coding integrated circuit 1000.

As described in connection with FIG. 4, the frequency dividers (such as 23) switch between ½ frequency divider 31 and ¼ frequency divider 32. However, a low frequency reference clock may be distributed to each section instead of a high frequency clock. In this case, the frequency divider (such as 23) in each functional block may be replaced with a frequency divider with PLL (Phase Locked Loop) so that each functional block can independently generate a required clock.

For delay adjustment, each frequency divider may be replaced with a frequency divider with DLL (Delay Locked Loop).

[Second Embodiment]

Image coding integrated circuit 1000 of the first embodiment is capable of processing an SDTV image.

An image coding integrated circuit 1000 of the second embodiment is capable of coding an HDTV image (1080I: an interlace image signal of 1,080 scanning lines).

In other words, image coding integrated circuit 1000 of the second embodiment is capable of processing 8,160 macroblocks in 1/30 second.

The second embodiment describes the structure capable of reducing power consumption according to an application in image coding integrated circuit 1000 capable of improving the resolution by extending the prediction range of motion predicting section 14.

In order to process an image with an extended prediction range as described above, it is necessary to improve parallel function of the predicting circuitry in proportion to the prediction range or to improve capability thereof by increasing the operating frequency.

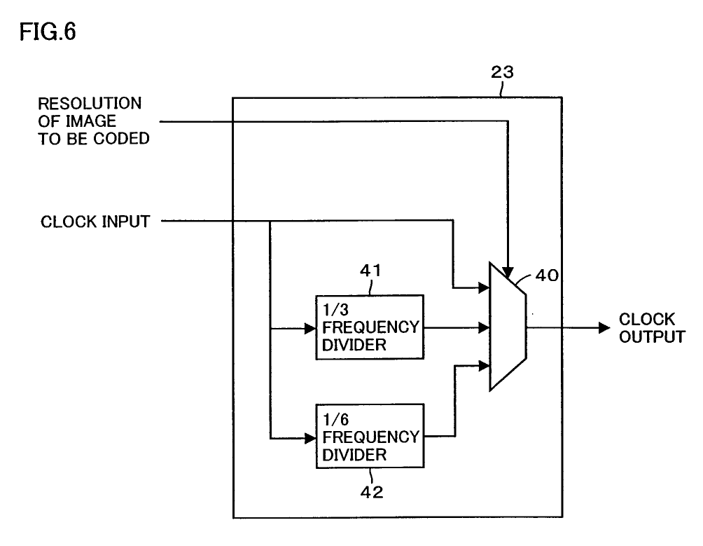

FIG. 6 is a schematic block diagram showing the structure of frequency divider 23 for loop processing section 13 in FIG. 3 according to the second embodiment. Note that frequency divider 25 for variable-length coding section 15 basically has the same structure as that of frequency divider 23.

Referring to FIG. 6, frequency divider 23 includes a ⅓ frequency divider 41, a ⅙ frequency divider 42 and a clock selector 40.

When a 1080I image is coded, clock selector 40 directly applies an input clock to loop processing section 13 as a clock signal. However, clock selector 40 selects the output of frequency divider 41 when a 480P image (a progressive image signal of 480 scanning lines) is coded, and selects the output of frequency divider 42 when a 480I image (an interlace signal of 480 scanning lines) is coded.

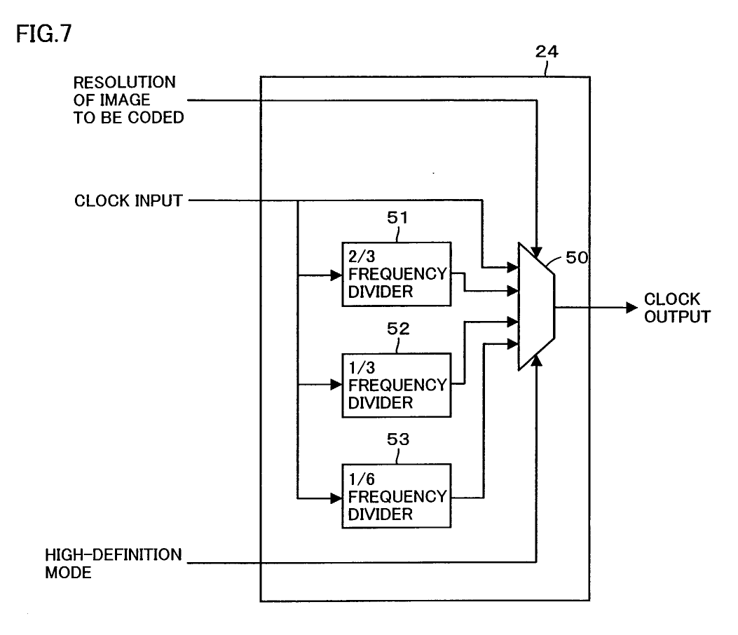

FIG. 7 is a schematic block diagram showing the structure of frequency divider 24 for motion predicting section 14.

Frequency divider 24 includes a ⅔ frequency divider 51, a ⅓ frequency divider 52, a ⅙ frequency divider 53 and a clock selector 50.

Frequency divider 24 additionally receives a high-definition mode signal from general control section 19. The high-definition mode signal designates a high-definition mode when it is at “H” level, and designates a normal mode when it is at “L” level.

In the normal mode, clock selector 50 of frequency divider 24 selects an input clock when a 1080I image is coded, selects the output of frequency divider 52 when a 480P image is coded, and selects the output of frequency divider 53 when a 480I image is coded.

In the high-definition mode, clock selector 50 of frequency divider 24 selects the input clock when a 1080I image is coded, selects the output of frequency divider 51 when a 480P image is coded, and selects the output of frequency divider 52 when a 480I image is coded.

General control section 19 simultaneously sends both a signal indicating a resolution of the image to be coded and a high-definition mode signal to each section so that each section can independently change a clock frequency.

In order to code a 480P image, image coding integrated circuit 1000 of the second embodiment is required to code 2,700 macroblocks. Accordingly, each of the sections involved in image coding operation (i.e., loop processing section 13, motion predicting section 14, variable-length coding section 15 and DRAM I/F section 18) need only exert half the respective processing capability.

On the other hand, video I/F section 12 receives the D1 image that has not been subjected to resolution conversion. Therefore, video I/F section 12 must exert its maximum processing capability. Since the resolution of the image has no influence on audio, audio I/F section 17 also need operate at a normal operating frequency.

Accordingly, in the normal mode, frequency dividers 23, 24, 25, 28 select one-third of the operating frequency, whereby power consumption of the sections involved in image coding operation (loop processing section 13, motion predicting section 14, variable-length coding section 15 and DRAM I/F section 18) can be reduced to about one-third.

On the other hand, in the high-definition mode, frequency dividers 23, 25, 28 select one-third of the operating frequency, whereby power consumption of the sections involved in image coding operation (loop processing section 13, variable-length coding section 15 and DRAM I/F section 18) can be reduced to about one-third. In the high-definition mode, motion predicting section 14 supports twice the motion prediction range of the normal mode. Therefore, frequency divider 24 for motion predicting section 14 selects two-thirds of the operating frequency, whereby power consumption of motion predicting section 14 can be reduced to two-thirds.

Since motion predicting section 14 is capable of independently suppressing its power consumption, the overall power consumption can be reduced while improving image quality.

In order to process a 4801 video signal in the normal mode, image coding integrated circuit 1000 is required to code 1,350 macroblocks. Accordingly, each of the sections involved in image coding operation (loop processing section 13, motion predicting section 14, variable-length coding section 15 and DRAM I/F section 18) need only exert one-sixth of the respective processing capability.

Therefore, frequency dividers 23, 24, 25, 28 select one-sixth of the operating frequency, whereby power consumption of the sections involved in image coding operation (loop processing section 13, motion predicting section 14, variable-length coding section 15 and DRAM I/F section 18) can be reduced to about one-sixth.

On the other hand, in the high-definition mode, frequency dividers 23, 25, 28 select one-sixth of the operating frequency, whereby power consumption of the sections involved in image coding operation (loop processing section 13, variable-length coding section 15 and DRAM I/F section 18) can be reduced to about one-sixth. In the high-definition mode, motion predicting section 14 supports twice the motion prediction range of the normal mode. Therefore, frequency divider 24 for motion predicting section 14 selects one-third of the operating frequency, whereby power consumption of motion predicting section 14 can be reduced to one-third.

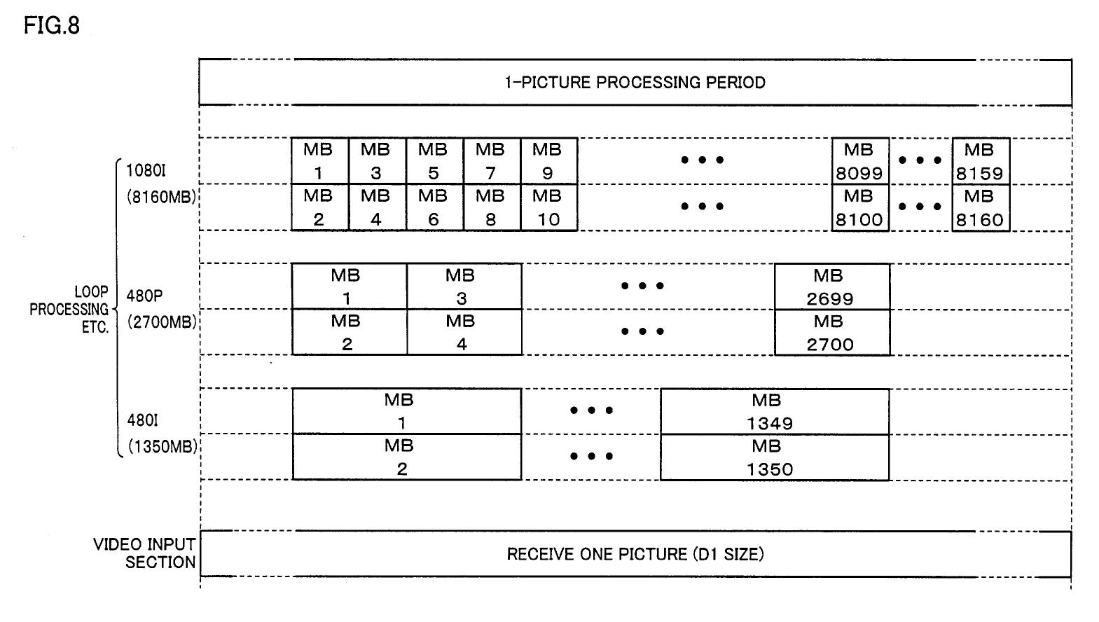

FIG. 8 is a timing chart illustrating operation according to each image format in the second embodiment.

In FIG. 8 as well, each box represents operation in one cycle. A smaller box represents operation at a higher frequency, and a larger box represents operation at a lower frequency.

FIG. 8 shows the operation of coding an HDTV image by using two parallel operation units. However, the present invention is not limited to this.

Like the first embodiment, the amount of operation in loop processing section 13 and motion predicting section 14 varies depending on the number of macroblocks to be coded. Therefore, as shown in FIG. 8, the operating frequency is reduced according to the total number of macroblocks corresponding to an image format, thereby enabling suppression of power consumption.

On the other hand, video I/F section 12 receives a fixed video format (in FIG. 8, 1080I size) from the outside. Therefore, the operation frequency cannot be reduced.

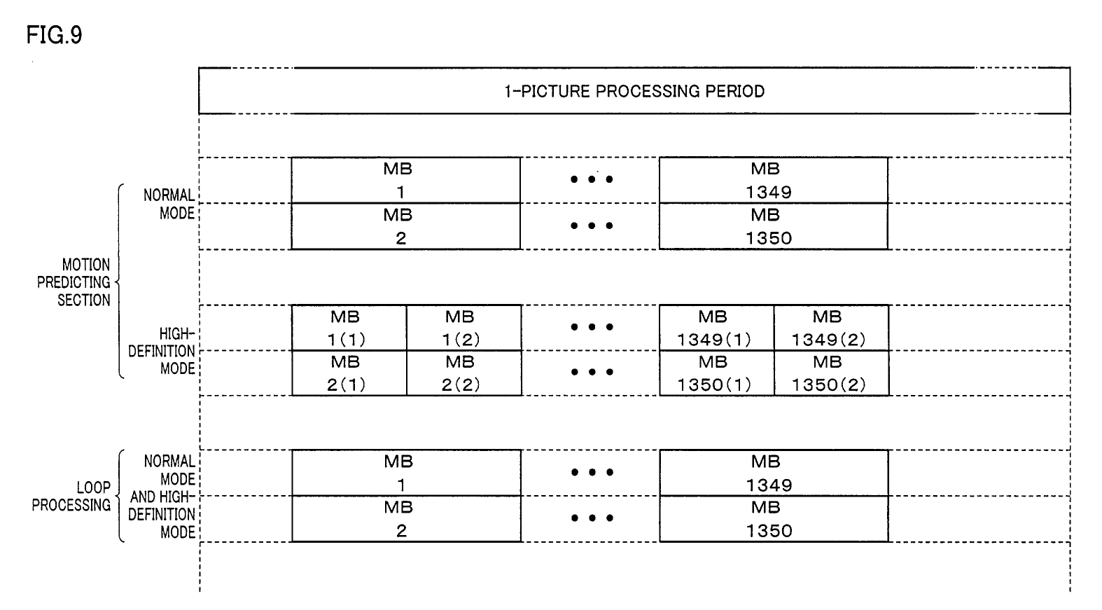

FIG. 9 is a timing chart in a period of processing a single picture in both normal and high-definition modes according to the second embodiment. Each box represents a single cycle.

In the high-definition mode, motion predicting section 14 implements twice the search range (the motion prediction range) of the normal mode by using twice the number of cycles in the normal mode. On the other hand, the number of cycles (the amount of operation) required for loop processing section 13 depends only on the number of macroblocks. Therefore, loop processing section 13 operates in the same number of cycles both in the normal mode and high-definition mode.

The sections involved in image coding operation consume a large amount of power due to large circuit scale and high operating frequency. However, appropriately selecting the operating frequency in these sections according to a resolution of the image enables significant reduction in the overall power consumption of the image coding integrated circuit.

Like the first embodiment, frequency dividers 23, 25, 28 may be integrated into a single circuit.

A low frequency reference clock may be distributed to each section instead of a high frequency clock. In this case, the frequency divider in each functional block may be replaced with a frequency divider with PLL.

For delay adjustment, each frequency divider may be replaced with a frequency divider with DLL.

[Third Embodiment]

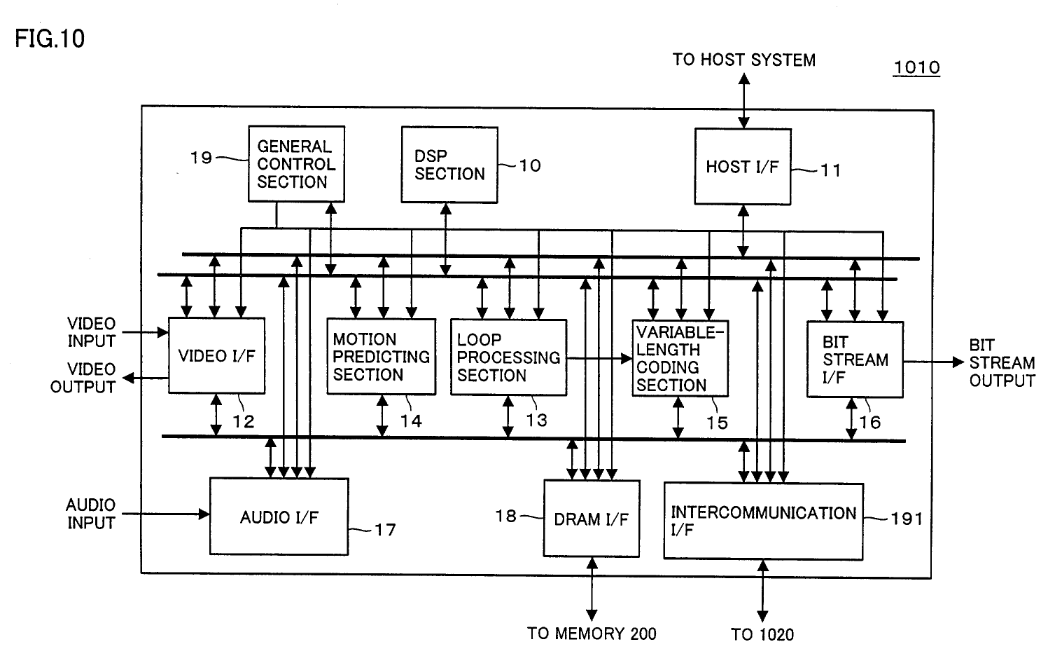

FIG. 10 is a schematic block diagram showing the structure of an image coding integrated circuit 1010 according to the third embodiment of the present invention.

Referring to FIG. 10, image coding integrated circuit 1010 includes a DSP section 10, a host interface (I/F) section 11, a video interface (I/F) section 12, a loop processing section 13, a motion predicting section 14, a variable-length coding section 15, a bit stream interface (I/F) section 16, an audio interface (I/F) section 17, a DRAM interface (I/F) section 18, a general control section 19 and an intercommunication interface (I/F) section 191.

Image coding integrated circuit 1010 of the third embodiment is different from image coding integrated circuit 1000 of the first embodiment in FIG. 1 in that image coding integrated circuit 1010 additionally includes intercommunication I/F section 191.

Intercommunication I/F section 191 is used to transfer required data between chips during multi-chip operation. For example, intercommunication I/F section 191 is an interface that allows a reconstructed image required for motion prediction to be transferred between chips.

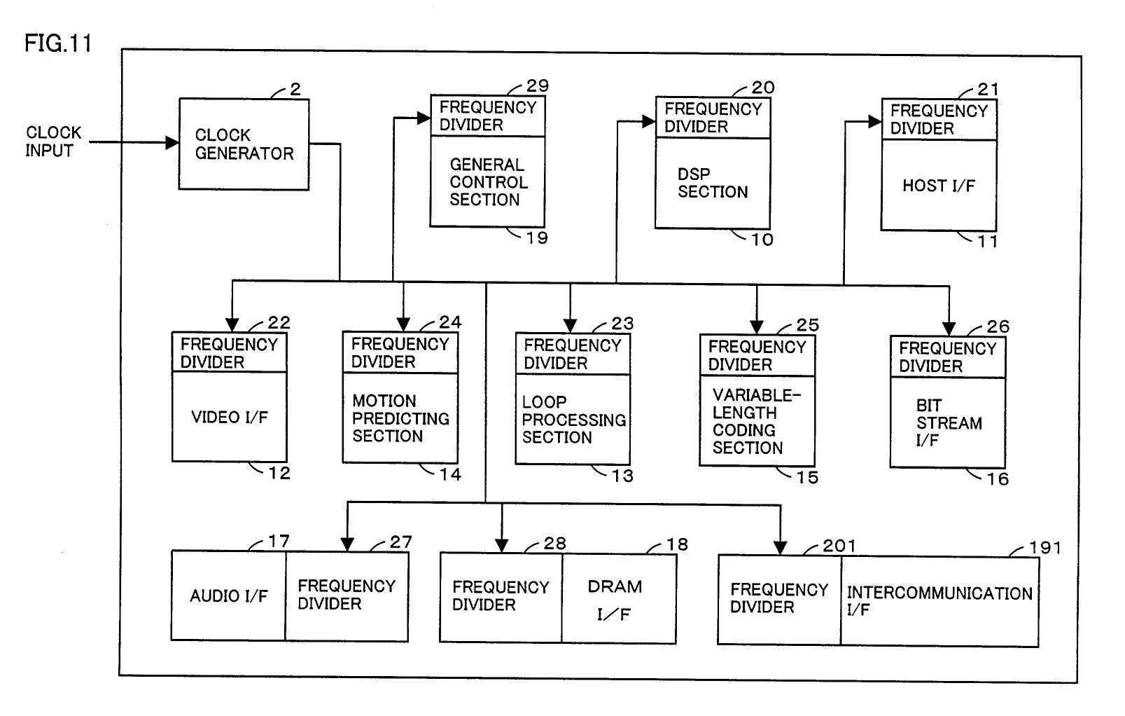

FIG. 11 is a schematic block diagram of clock distribution circuitry in image coding integrated circuit 1010 of FIG. 10.

Like the structure of FIG. 3, a clock generator 2 supplies a clock signal to the following frequency dividers through a clock supply line: a frequency divider 20 for DSP section 10; a frequency divider 21 for host I/F section 11; a frequency divider 22 for video I/F section 12; a frequency divider 23 for loop processing section 13; a frequency divider 24 for motion predicting section 14; a frequency divider 25 for variable-length coding section 15; a frequency divider 26 for bit stream I/F section 16; a frequency divider 27 for audio I/F section 17; a frequency divider 28 for DRAM I/F section 18; a frequency divider 29 for general control section 19; and a frequency divider 201 for intercommunication I/F section 191.

Clock generator 2 generates a clock having an operating frequency fO that is equal to the least common multiple of the operating frequencies of the above sections.

General control section 19 simultaneously sends a signal indicating a resolution of the image to be coded to each section so that each of the interface sections and the other sections can independently change the clock frequency.

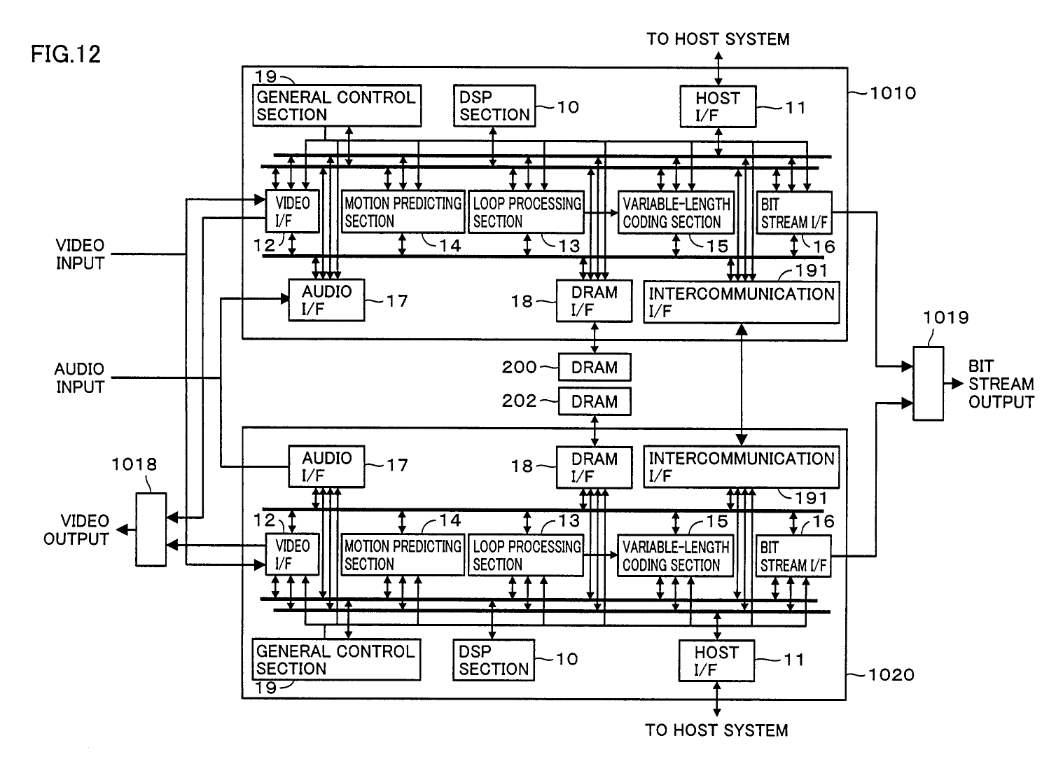

FIG. 12 is a schematic block diagram of the structure that implements operation of two chips (i.e., image coding integrated circuit 1010 in FIG. 11 and image coding integrated circuit 1020 having the same structure as that of image coding integrated circuit 1010).

This structure includes two image coding integrated circuits 1010, 1020, DRAMs 200, 202 respectively connected thereto, a multiplexer 1018 for video output, and a multiplexer 1019 for bit stream output.

These two chips are capable of operating in parallel to process a 1080I format in the high-definition mode.

In this case, each chip processes 4,080 macroblocks (i.e., half the total number of macroblocks).

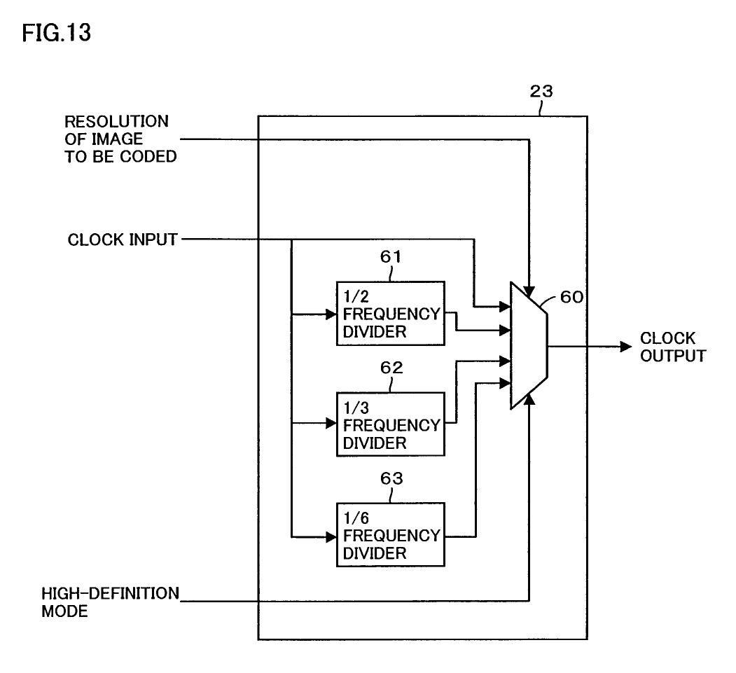

FIG. 13 is a schematic block diagram showing the structure of frequency divider 23 for loop processing section 13 described in connection with FIG. 11. Note that frequency divider 25 for variable-length coding section 15 basically has the same structure as that of frequency divider 23.

Frequency divider 23 of FIG. 13 is different from that of FIG. 6 in that frequency divider 23 of FIG. 13 additionally includes a ½ frequency divider 61.

This structure allows frequency divider 23 to select half the operating frequency when a 1080I format is processed in the high-definition mode.

When a video signal of 1080I format is applied in the high-definition mode, each of frequency dividers 23, 25, 28 selects half the respective operating frequency. This enables power consumption of the sections involved in image encoding operation (i.e., loop processing section 13, variable-length coding section 15 and DRAM I/F section 18) to be reduced about by half.

In the high-definition mode, motion predicting section 14 supports twice the motion prediction range of the normal mode, and frequency divider 24 for motion predicting section 14 selects the maximum operating frequency. Therefore, power consumption of motion predicting section 14 will not change. Since motion predicting section 14 is capable of independently suppressing its power consumption, the overall power consumption of the system can be reduced while improving image quality.

The sections involved in image coding operation consume a large amount of power due to large circuit scale and high normal operating frequency. However, appropriately selecting the operating frequency in these sections according to a resolution of the image enables significant reduction in the overall power consumption of the image coding integrated circuit.

Like the first embodiment, frequency dividers 23, 25, 28 may be integrated into a single circuit in order to reduce the area.

A low frequency reference clock may be distributed to each section instead of a high frequency clock. In this case, the frequency divider in each functional block may be replaced with a frequency divider with PLL.

For delay adjustment, each frequency divider may be replaced with a frequency divider with DLL.

[Fourth Embodiment]

The fourth embodiment describes the structure for reducing power consumption in a more adaptive manner by using the structure of the second embodiment.

Like the second embodiment, an image coding integrated circuit 1000 of the fourth embodiment is capable of coding an HDTV image (1080I).

In other words, image coding integrated circuit 1000 of the fourth embodiment is capable of processing 8,160 macroblocks in 1/30 second.

The fourth embodiment implements the structure of the image coding integrated circuit that suppresses power consumption by reducing the prediction range of the motion predicting section when it can be determined in advance that the motion prediction range is narrow or when quality requirement for the compressed image is not strict in the application.

The prediction range can be reduced by degrading parallel function of the predicting circuitry in proportion to the prediction range or by degrading capability thereof by reducing the operating frequency.

Like the second embodiment, the structure of the frequency divider in FIG. 6 is applied to frequency divider 23 for loop processing section 13 and frequency divider 25 for variable-length coding section 15 in FIG. 1. Each frequency divider 23, 25 selects an input clock when a 1080I image is coded, selects the output of frequency divider 41 when a 480P image is coded, and selects the output of frequency divider 42 when a 480I image is coded.

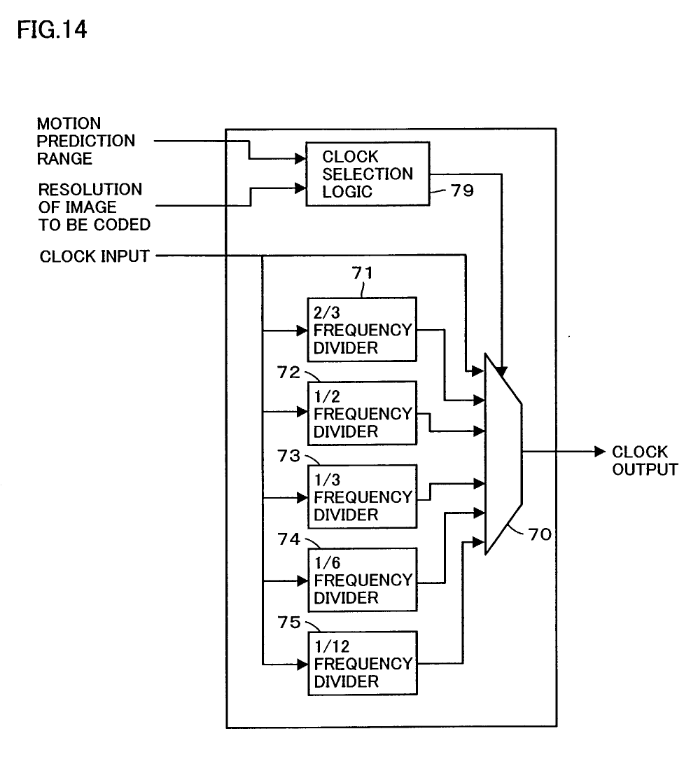

FIG. 14 is a schematic block diagram showing the structure of a frequency divider 24 for motion predicting section 14 according to the fourth embodiment.

Frequency divider 24 includes a ⅔ frequency divider 71, a ½ frequency divider 72, a ⅓ frequency divider 73, a ⅙ frequency divider 74, a 1/12 frequency divider 75, a clock selector 70 and a clock selection logic 79.

Clock selection logic 79 receives a motion prediction range and an image format and outputs a clock selection signal.

For example, the following three prediction ranges and three image formats (resolutions of the image to be coded) are prepared: “wide (twice the normal prediction range)”, “normal” and “narrow (half the normal prediction range)”; and “1080I”, “480P” and “480I”. However, the present invention is not limited to this.

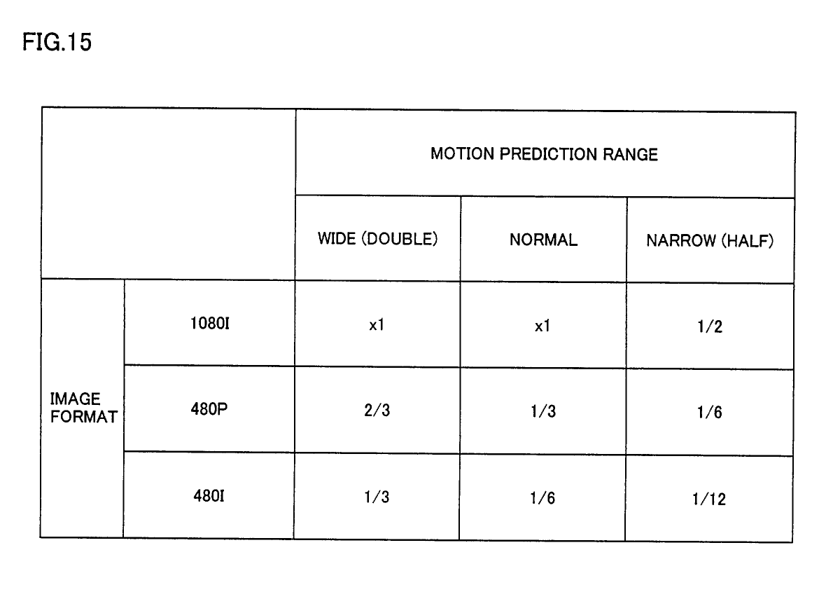

FIG. 15 shows frequency division ratios that are selected according to the above prediction ranges and image formats.

As shown in FIG. 15, clock selector 70 supplies to motion prediction section 14 a clock signal having a frequency divided according to a motion prediction range and an image format.

In the fourth embodiment as well, general control section 19 simultaneously sends a signal indicating a resolution of the image to be coded and a motion prediction range signal to each section so that each section can independently change a clock frequency.

When the image coding integrated circuit of the fourth embodiment codes a 1080I image, the sections other than motion prediction section 14 must exert their maximum processing capability. For example, however, when motion prediction section 14 has a narrow motion prediction range, it need only exert half the normal processing capability thereof.

Accordingly, frequency divider 24 for motion predicting section 14 selects half the operating frequency, whereby power consumption of motion predicting section 14 can be reduced by half.

Since motion predicting section 14 is capable of independently suppressing its power consumption and adaptively suppressing its processing capability, the overall power consumption can be reduced while maintaining the image quality.

As described in the second embodiment, in order to process a 480I video signal in the normal mode, each of frequency dividers 23, 24, 25, 28 selects one-sixth of the operating frequency. This enables power consumption of the sections involved in image coding operation (loop processing section 13, motion predicting section 14, variable-length coding section 15 and DRAM I/F section 18) to be reduced to about one-sixth.

In the normal motion prediction range, motion predicting section 14 need only exert one-sixth of the normal processing capability since the image format is 480I. When the motion prediction range is reduced (i.e., in the narrow prediction range), motion predicting section 14 need only exert half the above processing capability. This corresponds to selecting one-twelfth of the operating frequency by frequency divider 24, whereby power consumption of motion predicting section 14 can be reduced to one-twelfth.

The sections involved in image coding operation consume a large amount of power due to large circuit scale and high operating frequency. However, appropriately selecting the operating frequency in these sections according to a resolution of the image enables significant reduction in the overall power consumption of the image coding integrated circuit.

[Fifth Embodiment]

The fifth embodiment describes the structure that enables further reduction in power consumption by using a specific layout of the image coding integrated circuit of the second embodiment.

The fifth embodiment reduces power consumption by reducing a power supply voltage when suppressing an operating frequency. In this case, regions of the functional blocks must be physically separated from each other so that the functional blocks can control the power supply voltage independently of each other.

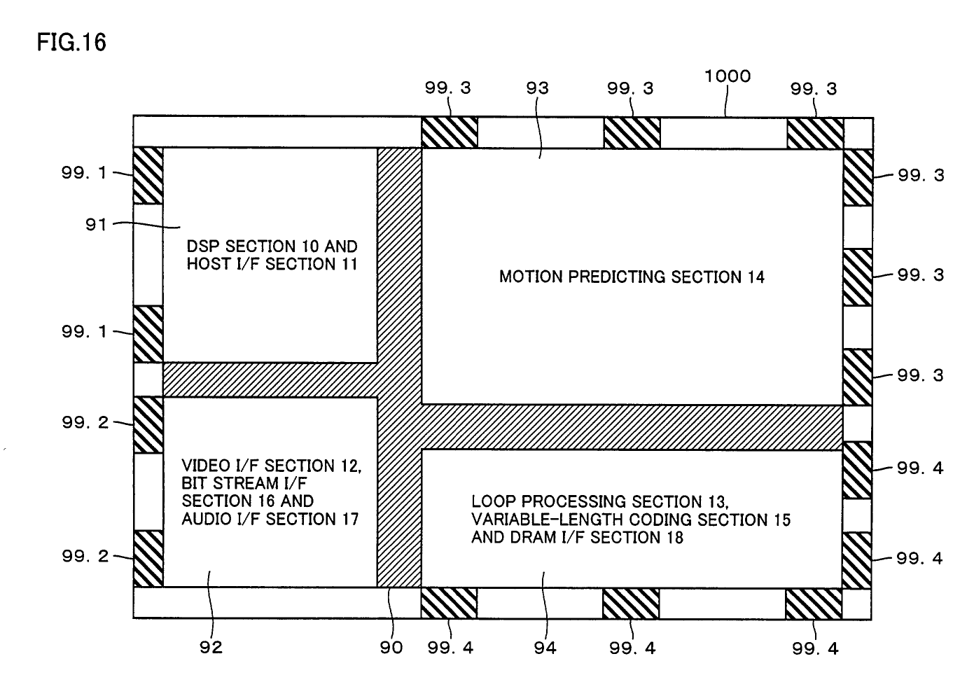

FIG. 16 is a conceptual diagram showing a specific on-chip layout of image coding integrated circuit 1000 of the second embodiment.

In the illustrated example, a region 91 is allocated to DSP section 10 and host I/F section 11, and a region 92 is allocated to video I/F section 12, bit stream I/F section 16 and audio I/F section 17. Moreover, a region 93 is allocated to motion predicting section 14, and a region 94 is allocated to loop processing section 13, variable-length coding section 15 and DRAM I/F section 18. A region 90 for clock generation and clock distribution is also provided.

Power supply voltage regulators 99.1 to 99.4 are arranged in a dispersed manner in an input/output (I/O) section of image coding integrated circuit 1000.

More specifically, power supply voltage regulators 99.1 are provided for region 91 of DSP section 10 and host I/F section 11, power supply voltage regulators 99.2 are provided for region 92 of video I/F section 12, bit stream I/F section 16 and audio I/F section 17, power supply voltage regulators 99.3 are provided for region 93 of motion predicting section 14, and power supply voltage regulators 99.4 are provided for region 94 of loop processing section 13, variable-length coding section 15 and DRAM interface section 18. Power supply regulators 99.1 to 99.4 control a voltage independently of each other according an image format.

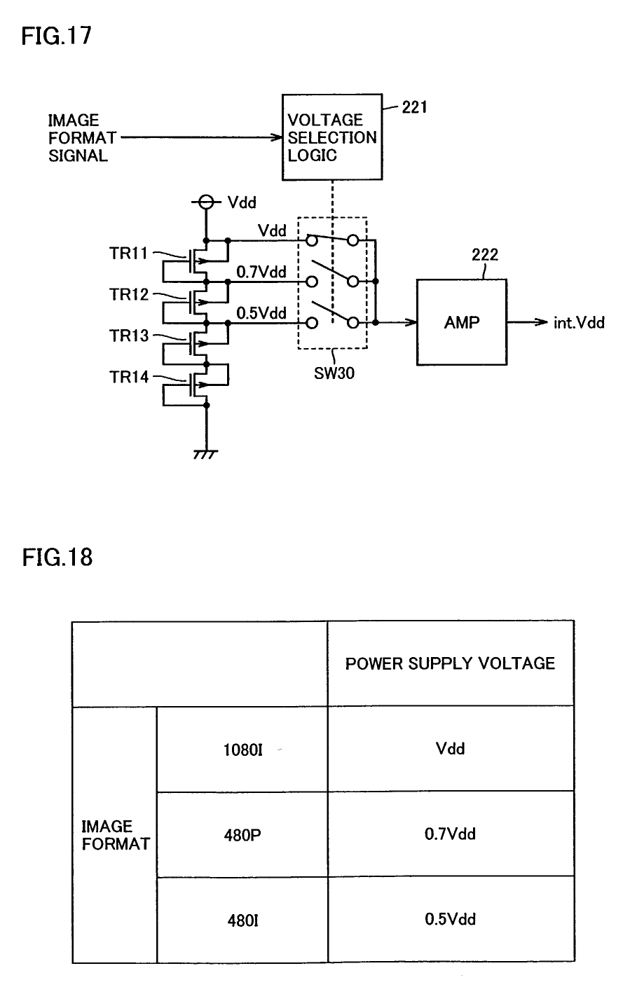

FIG. 17 is a schematic block diagram showing the structure of power supply voltage regulator 99.1. The other power supply voltage regulators 99.2 to 99.4 basically have the same structure as that of power supply voltage regulator 99.1.

Power supply voltage regulator 99.1 includes N-channel MOS (Metal Oxide Semiconductor) transistors TR11 to TR14 connected in series between a power supply voltage Vdd and a ground voltage Vss. Transistors TR11 to TR14 are diode-connected.

Power supply voltage regulator 99.1 further includes an amplifier 222 for outputting an internal power supply potential int. Vdd, a switch circuit SW30, and a voltage selection logic 221 for controlling switch circuit SW30 in response to an image format signal. Switch circuit SW30 selectively applies to amplifier 222 a potential on one of a connection node between transistor TR11 and power supply voltage Vdd, a connection node between transistors TR11 and TR12 and a connection node between transistors TR12 and TR13.

Power supply voltage regulator 99.1 thus selects a desired voltage by generating a selection signal by voltage selection logic 221 according to an image format signal. The selected voltage is amplified by amplifier 221 for distribution to each power supply node.

FIG. 18 illustrates operation of power supply voltage regulator 99.1 in FIG. 17.

When the image format is 1080I, power supply voltage Vdd is selected and applied to amplifier 222. When the image format is 480P, a potential on the connection node between transistors TRIL and TR12 (e.g., 0.7 Vdd) is selected and applied to amplifier 222.

When the image format is 480I, a potential on the connection nodes between transistors TR12 and TR13 (e.g., 0.5 Vdd) is selected and applied to amplifier 222.

When the power supply voltage is reduced, power consumption can be reduced in proportion to the square of the voltage.

Note that, in the example of FIG. 16, the functional blocks are arranged in four regions and power supply voltage regulator 99 is provided for each region. However, power supply voltage regulator 99 may alternatively be provided for each functional block such as DSP section 10.

[Sixth Embodiment]

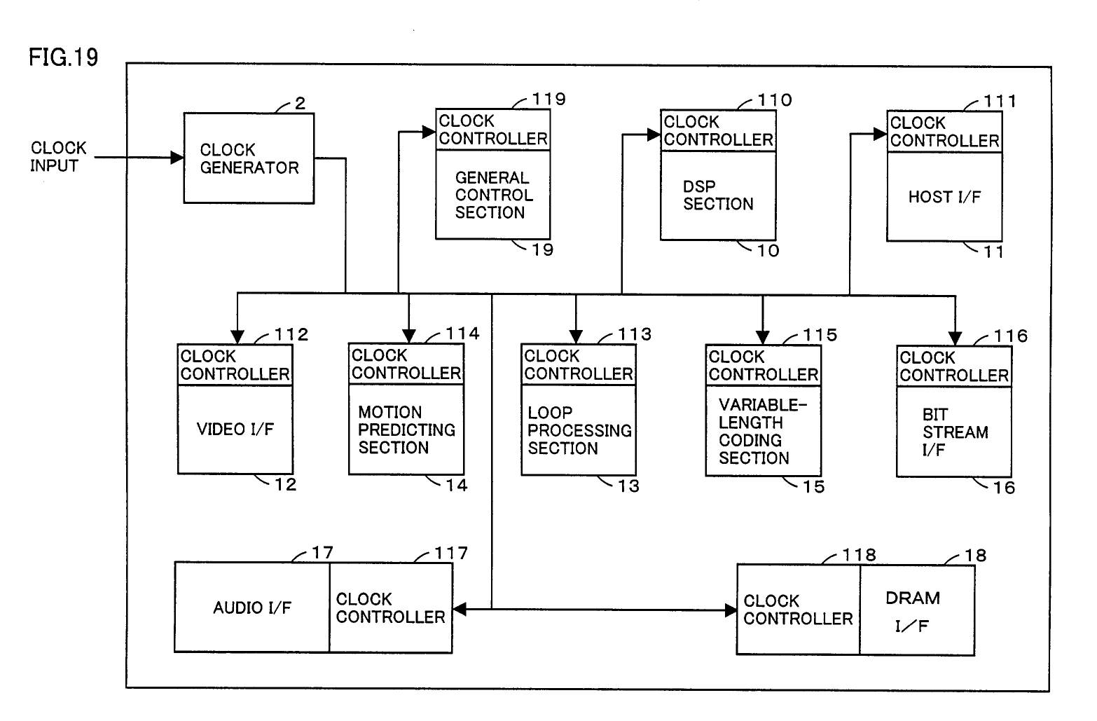

FIG. 19 is a schematic block diagram showing another structure of clock distribution circuitry in image coding integrated circuit 1000 of FIG. 1.

Referring to FIG. 19, clock generator 2 supplies a clock signal to the following clock controllers through a clock supply line: a clock controller 110 for DSP section 10; a clock controller 111 for host I/F section 11; a clock controller 112 for video I/F section 12; a clock controller 113 for loop processing section 13; a clock controller 114 for motion predicting section 14; a clock controller 115 for variable-length coding section 15; a clock controller 116 for bit stream I/F section 16; a clock controller 117 for audio I/F section 17; a clock controller 118 for DRAM I/F section 18; and a clock controller 119 for general control section 19.

Each clock controller 110 to 119 has a function to suppress a clock as necessary.

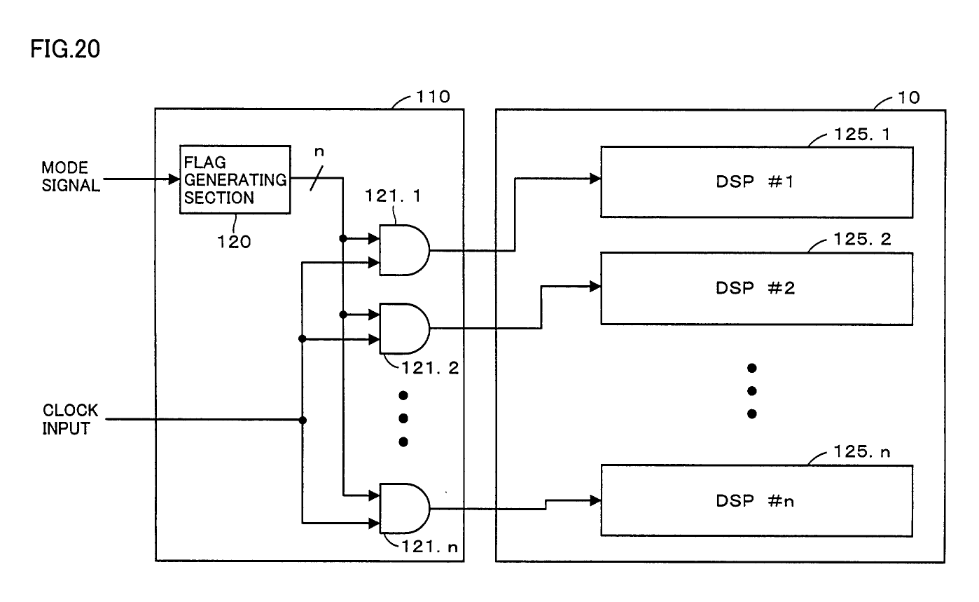

FIG. 20 is a schematic block diagram showing the structure of DSP section 10 and clock controller 110 for DSP section 10.

Clock controller 110 includes a flag generating section 120 for generating a flag indicating valid/invalid of an output clock according to a mode signal, and n output clock gates 121.1 to 121.n (where n is a natural number).

DSP section 10 includes n DSP circuits 125.1 to 125.n arranged in parallel (where n is a natural number).

Clock controller 110 receives a single input clock and a mode signal and outputs n clocks (where n is a natural number). The mode signal from general control section 19 is a signal indicating a video/audio/system coding mode. For example, the video coding mode includes the resolutions of an image described above.

For example, a monitoring camera system does not require audio coding operation. Therefore, of DSP circuits 125.1 to 125.n, supply of a clock to a DSP circuit for audio coding operation is selectively discontinued, whereby power consumption of the DSP circuit for audio coding operation can be suppressed.

In this case, all operation units in clock controller 117 for audio I/F section 17 are stopped, whereby power consumption can be suppressed.

[Seventh Embodiment]

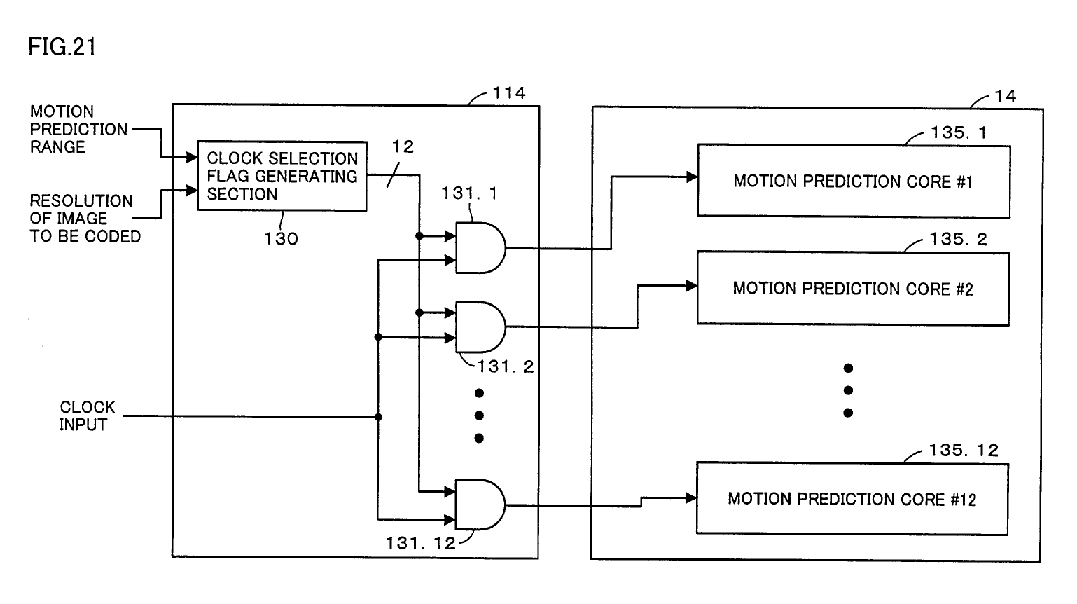

FIG. 21 shows the structure of motion predicting section 14 and clock controller 114 for motion predicting section 14 in image coding integrated circuit 1000 for 1080I format having the clock distribution circuitry described in connection with FIG. 19.

Clock controller 114 includes a clock selection flag generating section 130 for generating a clock selection flag according to an operational mode, and twelve output clock gates 131.1 to 131.12.

Motion predicting section 14 includes twelve motion prediction cores 135.1 to 135.12 arranged in parallel.

Based on combination of a signal indicating a resolution of the image to be coded and a signal indicating a motion prediction range described in the fourth embodiment, clock selection flag generating section 130 generates a clock selection flag. A clock signal is thus selectively supplied only to a motion prediction core (or cores) selected from motion prediction cores 135.1 to 135.12.

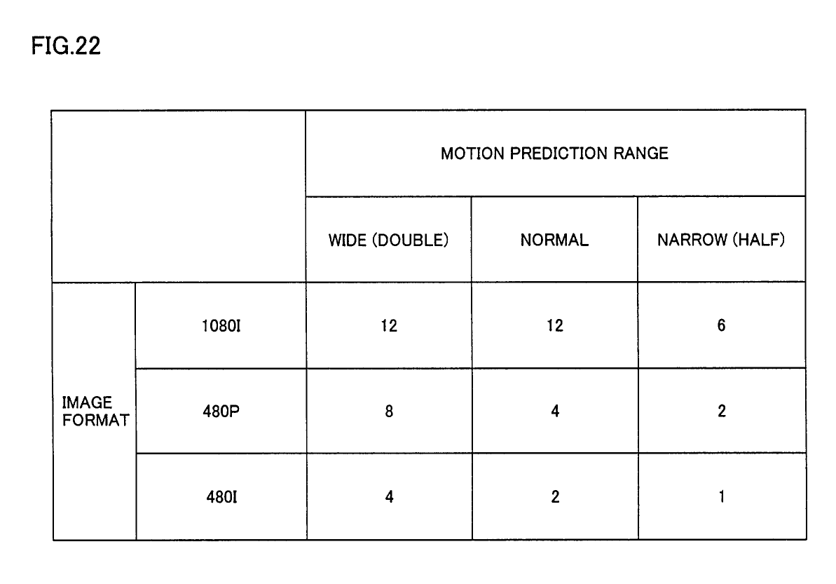

FIG. 22 shows the number of motion prediction cores selected according to a motion prediction range and an image format.

For example, when the image format is 1080I and the wide motion prediction range is designated, all motion prediction cores (twelve motion prediction cores) are operated. On the other hand, when the image format is 1080I and the narrow motion prediction range is designated, only six motion prediction cores are operated.

When the image format is 480I and the narrow motion prediction range is designated, only one motion prediction core in motion prediction section 14 is operated. Accordingly, power consumption of motion predicting section 14 can be suppressed to one-twelfth.

[Eighth Embodiment]

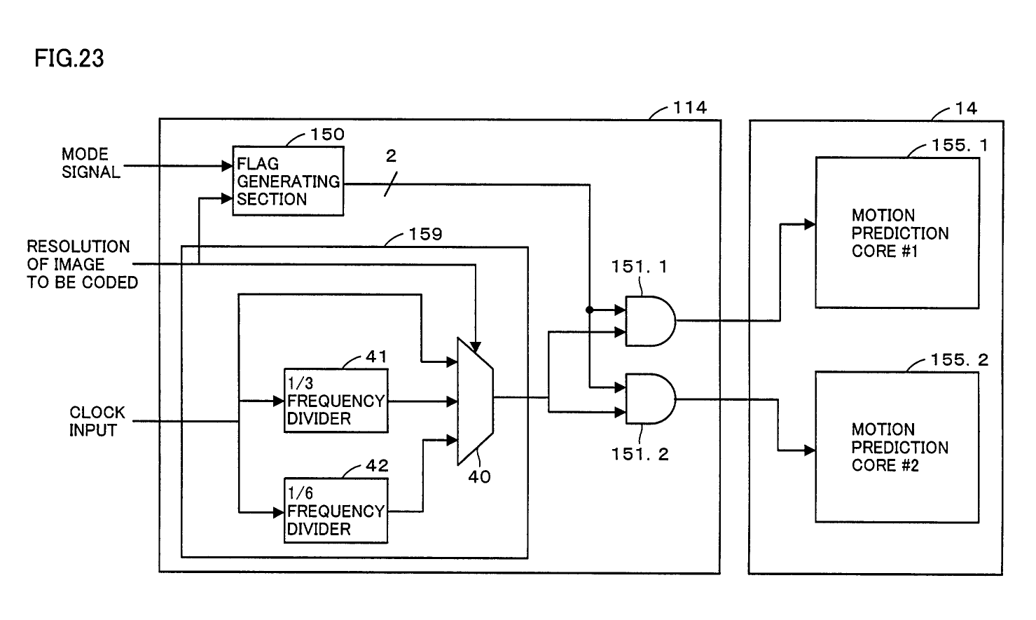

FIG. 23 is a schematic block diagram showing another structure of motion predicting section 14 and clock controller 114 for motion predicting section 14 in image coding integrated circuit 1000 for 1080I format having the clock distribution circuitry described in connection with FIG. 19.

Clock controller 114 includes a flag generating section 150 for generating a clock selection flag according to a mode signal, two output clock gates 151.1, 151.2 and a frequency divider 159. Frequency divider 159 has the same structure as that of frequency divider 23 of the second embodiment shown in FIG. 6.

Reduction in power consumption according to a resolution of an image is implemented by frequency divider 159. Reduction in power consumption according to a motion prediction range is implemented by selecting motion prediction core 155.1 or 155.2 by selectively activating output clock gates 151.1, 151.2 according to the flag generated by flag generating section 150.

Reduction in power consumption can further be facilitated by reducing an operating frequency in the manner described in the fifth embodiment.

For example, when the image format is 480I and the narrow prediction range is designated, search operation can be conducted by selecting one-sixth of the operating frequency and operating only one of two motion prediction cores 155.1, 155.2. Accordingly, power consumption of motion predicting section 14 can be reduced to one-twelfth.

Moreover, controlling a power supply voltage would enable the above power consumption to be further reduced to about a quarter. Therefore, the overall power consumption of the image coding integrated circuit can be reduced to 1/48.

[Ninth Embodiment]

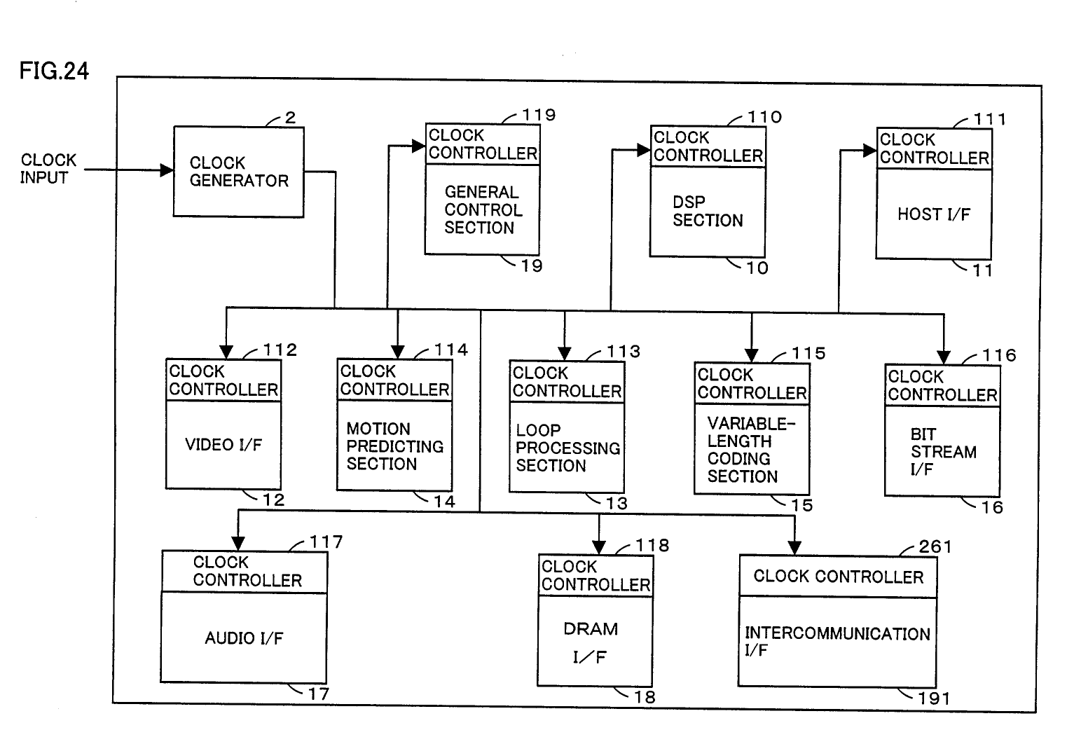

FIG. 24 is a conceptual diagram of another clock distribution circuitry in image coding integrated circuit 1010 of FIG. 10.

Clock generator 2 supplies a clock signal to the following clock controllers through a clock supply line: a clock controller 110 for DSP section 10; a clock controller 111 for host I/F section 11; a clock controller 112 for video I/F section 12; a clock controller 113 for loop processing section 13; a clock controller 114 for motion predicting section 14; a clock controller 115 for variable-length coding section 15; a clock controller 116 for bit stream I/F section 16; a clock controller 117 for audio I/F section 17; a clock controller 118 for DRAM I/F section 18; a clock controller 119 for general control section 19; and a clock controller 261 for intercommunication I/F section 191.

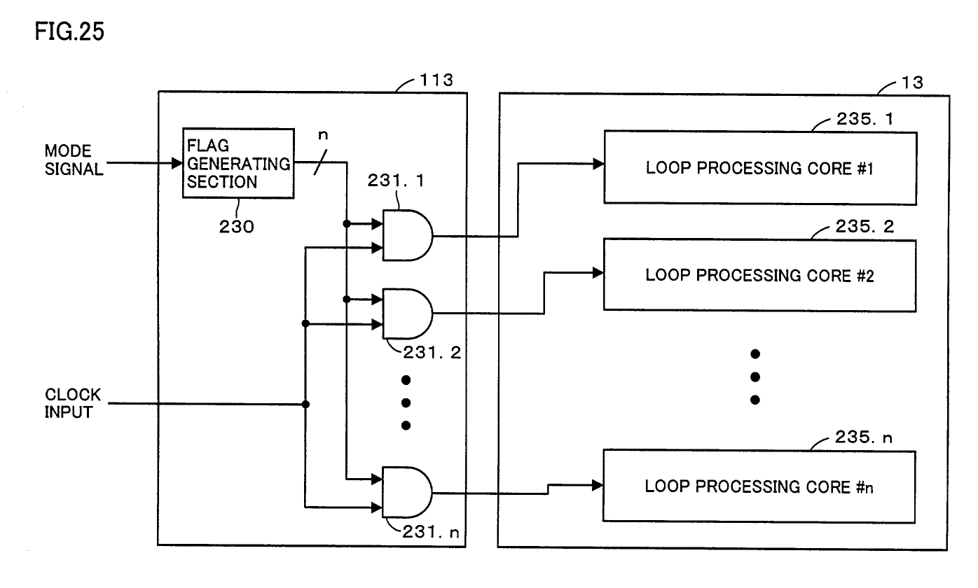

FIG. 25 is a schematic block diagram illustrating the structure of loop processing section 13 and clock controller 113 for loop processing section 13 in image coding integrated circuit 1010 for 1080I format having the clock distribution circuitry described in connection with FIG. 24.

Clock controller 113 includes a clock selection flag generating section 230 for generating a clock selection flag according to a mode signal, and n output clock gates 231.1 to 231.n (where n is a natural number).

Loop processing section 13 includes n loop processing cores 235.1 to 235.n capable of operating in parallel (where n is a natural number).

For example, in order to code a 480I video signal, only n/6 loop processing cores need be operated.

Accordingly, power consumption of motion predicting section 14 can be reduced to one-sixth.

[Tenth Embodiment]

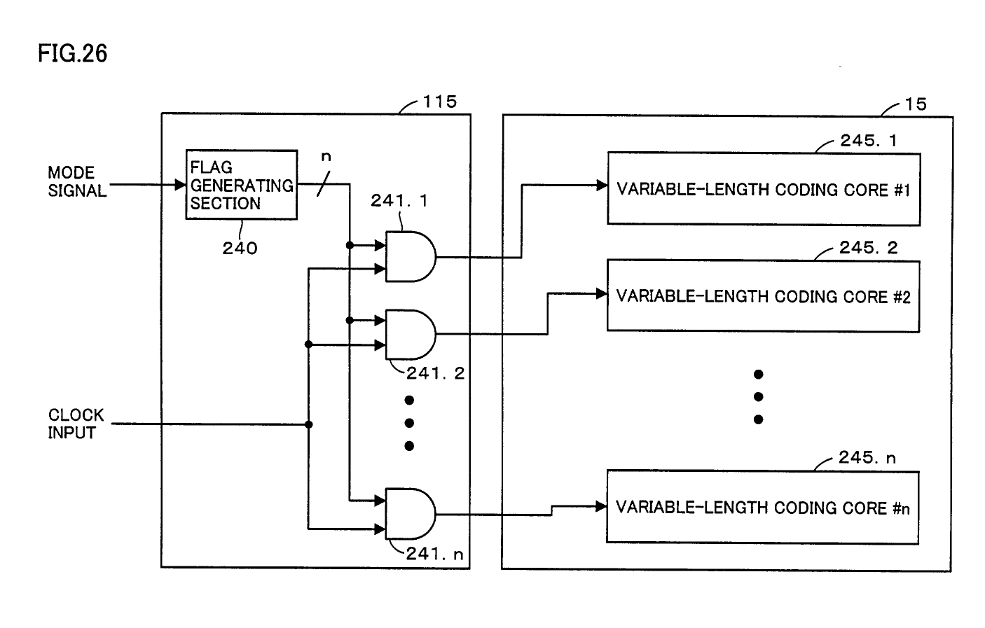

FIG. 26 is a schematic block diagram illustrating the structure of variable-length coding section 15 and clock controller 115 for variable-length coding section 15 in image coding integrated circuit 1010 for 1080I format having the clock distribution circuitry described in connection with FIG. 24.

Clock controller 115 includes a clock selection flag generating section 240 for generating a clock selection flag according to a mode signal, and n output clock gates 241.1 to 241.n (where n is a natural number).

Variable-length coding section 15 includes n variable-length coding cores 245.1 to 245.n capable of operating in parallel (where n is a natural number).

For example, in order to code a 480I video signal, only n/6 variable-length coding cores need only be operated.

Accordingly, power consumption of motion predicting section 14 can be reduced to one-sixth.

[Eleventh Embodiment]

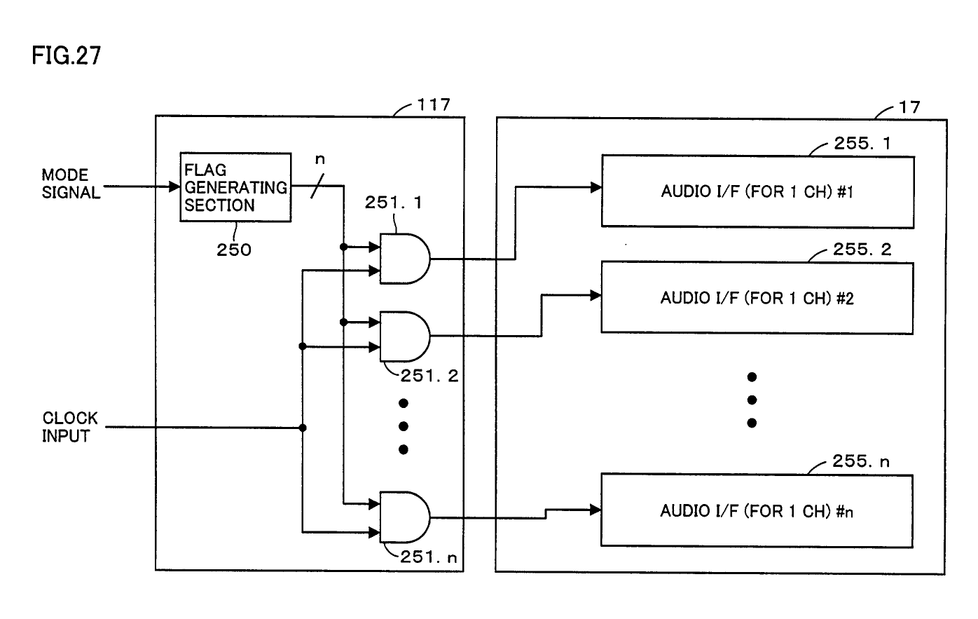

FIG. 27 is a schematic block diagram illustrating the structure of audio I/F section 17 and clock controller 117 for audio I/F section 17 in image coding integrated circuit 1010 for 1080I format having the clock distribution circuitry described in connection with FIG. 24.

Clock controller 117 includes a clock selection flag generating section 250 for generating a clock selection flag according to a mode signal, and n output clock gates 251.1 to 251.n (where n is a natural number).

Audio I/F section 17 includes n audio interfaces (I/Fs) 255.1 to 255.n capable of operating in parallel (where n is a natural number).

For example, in order to code an audio signal corresponding to two channels, only two of the n audio I/Fs need only be operated.

Accordingly, power consumption of motion predicting section 14 can be reduced to 2/n.

Note that the individual structures of the sixth to eleventh embodiments or any combination thereof may further be combined with power supply voltage regulators 99.1 to 99.4 of the fifth embodiment shown in FIG. 16.

As described in connection with FIG. 16, every region 91 to 94 can be provided with a corresponding power supply voltage regulator 99.1 to 99.4. However, only one of regions 91 to 94 may alternatively be provided with a corresponding power supply voltage regulator. It is also possible to provide each region 91 to 94 with a corresponding power supply voltage regulator or provide the structure for selectively supplying an operating clock to a plurality of processing cores (or interfaces) capable of operating in parallel as described in the sixth to eleventh embodiments. Alternatively, it is possible to provide at least one or all of regions 91 to 94 with a corresponding power supply voltage regulator and provide the structure for selectively supplying an operating clock to a plurality of processing cores (or interfaces) capable of operating in parallel as described in the sixth to eleventh embodiments.

Although the present invention has been described and illustrated in detail, it is clearly understood that the same is by way of illustration and example only and is not to be taken by way of limitation, the sprit and scope of the present invention being limited only by the terms of the appended claims.

What is claimed is:

1. An image coding integrated circuit, comprising:
an image signal interface for receiving and outputting image data from and to outside;
an audio signal interface for receiving an audio signal from the outside;
a motion predicting section for conducting motion prediction of said image data;
a loop processing section for predictive-coding each image data based on a plurality of image data at different points of time on a time base and said motion prediction result;
a processor section for coding at least said audio signal;
a memory interface section for receiving and outputting data from and to a memory device for storing said image data; and
a clock signal supply circuit for separately adjusting a frequency of an operating clock signal to be supplied to said image signal interface, said audio signal interface, said motion predicting section, said loop processing section, said processor section and said memory interface section according to processing load of said image coding integrated circuit for said image data.

2. The image coding integrated circuit according to claim 1, wherein said processing load of said image coding integrated circuit is determined at least by a resolution of an image and a parameter of image quality in operation of coding said image data.

3. The image coding integrated circuit according to claim 1, wherein said clock signal supply circuit includes
a clock generator for generating a reference clock signal,
a plurality of frequency converters for converting said reference clock signal to a prescribed frequency, and
a selection circuit for selectively supplying outputs of said plurality of frequency converters according to said processing load.

4. The image coding integrated circuit according to claim 3, further comprising:
a power supply voltage reducing circuit for separately reducing a power supply potential to be supplied to said image signal interface, said audio signal interface, said motion predicting section, said loop processing section, said processor section and said memory interface section by a prescribed value when said operating clock signal having a frequency lower than that of said reference clock signal is supplied.

5. The image coding integrated circuit according to claim 3, wherein said plurality of frequency converters are a plurality of frequency dividers.

6. The image coding integrated circuit according to claim 5, wherein said plurality of frequency dividers are respectively provided for said image signal interface, said audio signal interface, said motion predicting section, said loop processing section, said processor section and said memory interface section.

7. The image coding integrated circuit according to claim 5, wherein said loop processing section and said memory interface section share one of said plurality of frequency dividers.

8. An image coding integrated circuit, comprising:
an image signal interface for receiving and outputting image data from and to outside;
an audio signal interface for receiving an audio signal from the outside;
a motion predicting section for conducting motion prediction of said image data;
a loop processing section for predictive-coding each image data based on a plurality of image data at different points of time on a time base and said motion prediction result;
a processor section for coding at least said audio signal; and
a memory interface section for receiving and outputting data from and to a memory device for storing said image data, wherein
at least one of said image signal interface, said audio signal interface, said motion predicting section, said loop processing section, said processor section and said memory interface section includes a plurality of operation units for conducting a corresponding operation in parallel,
said image coding integrated circuit further comprising:
a clock signal supply circuit capable of separately discontinuing supply of an operating clock signal to said plurality of operation units according to processing load of said image coding integrated circuit for said image data.

9. The image coding integrated circuit according to claim 8, wherein said processor section includes as said plurality of operation units a plurality of processor circuits for coding said audio signal in parallel.

10. The image coding integrated circuit according to claim 8, wherein said motion predicting section includes as said plurality of operation units a plurality of motion prediction cores for conducting motion prediction of said image data in parallel.

11. The image coding integrated circuit according to claim 8, wherein said loop processing section includes as said plurality of operation units a plurality of loop processing cores for predictive-coding each image data in parallel based on a plurality of image data at different points of time on a time base and said motion prediction result.

12. The image coding integrated circuit according to claim 8, wherein said audio signal interface includes as said plurality of operation units a plurality of interface circuits for interfacing with a corresponding audio channel in parallel.

13. The image coding integrated circuit according to claim 9, further comprising:
a power supply voltage reducing circuit for reducing a power supply voltage to be supplied by a prescribed value when supply of said operating clock signal is selectively discontinued.
